(19) United States
(12) Patent Application Publication
(10) Pub. No.: US 2026/0161128 A1
(43) Pub. Date: Jun. 11, 2026

(54) IMAGE FORMING DEVICE THAT FIXES IMAGE TO SHEET USING HEAT

(71) Applicant: CANON KABUSHIKI KAISHA, Tokyo (JP)

(72) Inventors: AKIHIKO UCHIYAMA, Shizuoka (JP); KEN YOKOYAMA, Shizuoka (JP)

(21) Appl. No.: 19/410,009

(22) Filed: Dec. 5, 2025

(30) Foreign Application Priority Data
Dec. 11, 2024 (JP) 2024-216890

(51) Int. Cl. G03G 15/00; G03G 15/16; G03G 15/20

(52) U.S. Cl. CPC G03G 15/657; G03G 15/167; G03G 15/206; G03G 15/2064; G03G 15/5029; G03G 2215/00556; G03G 2215/00742; G03G 2215/2035

(57) ABSTRACT

A guiding member is positioned between a transfer roller and a pressure roller. The guiding member guides a lower surface of a recording material so as to direct, toward a fixing nip, the recording material which has passed through a transfer nip, which is a nip between a photosensitive drum and the transfer roller. In a case where a temperature of the pressure roller is low, a movement control unit controls a moving member so that the guiding member is positioned at a second position. In a case where a temperature of the pressure roller is high, the movement control unit controls the moving member so that the guiding member is positioned at a first position.

### BACKGROUND

### Field of the Technology

The present disclosure relates to an image forming device that fixes an image to a sheet using heat.

### Description of the Related Art

A fixing device described in Japanese Patent Laid-Open No. 2024-031208 includes a heating unit including a heater that heats an inner surface of a belt, and a pressure roller that forms a nip portion together with the heater via the belt, and fixes a toner on a recording material.

### SUMMARY

The present disclosure provides an image forming apparatus comprising: a photosensitive drum; a transfer roller for transferring a developer on the photosensitive drum to a recording material; a heating unit including an endless belt, and a heater that is provided on an inner surface side of the belt and heats the belt; a pressure roller including a rubber layer that forms a fixing nip together with the heater via the belt; a guiding member positioned between the transfer roller and the pressure roller in a conveyance direction in which the transfer roller conveys the recording material, the guiding member guiding a lower surface of the recording material so as to direct, toward the fixing nip, the recording material which has passed through a transfer nip, which is a nip between the photosensitive drum and the transfer roller; a moving member that moves the guiding member to a first position or a second position positioned below the first position; and a movement control unit that controls movement of the moving member. In a case where a temperature of the pressure roller is lower than a predetermined threshold, the movement control unit controls the moving member so that the guiding member is positioned at the second position. In a case where a temperature of the pressure roller is higher than the predetermined threshold, the movement control unit controls the moving member so that the guiding member is positioned at the first position.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view describing an image forming device.

FIG. 2 is a view describing a fixing device.

FIGS. 3A and 3B are views describing a conveyance guide.

FIG. 4 is a view describing a controller.

FIG. 5 is a view describing functions implemented by a CPU.

FIG. 6 is a flowchart showing a control method of a first embodiment.

FIG. 7 is a flowchart showing a control method of a second embodiment.

FIG. 8 is a flowchart showing a control method of the second embodiment.

FIG. 9 is a view describing a bending height of a recording material.

FIG. 10 is a flowchart showing a control method of a third embodiment.

FIG. 11 is a flowchart showing a control method of the third embodiment.

FIGS. 12A and 12B are views describing a left-right difference of a printing ratio.

FIG. 13 is a flowchart showing a control method of a fourth embodiment.

FIG. 14 is a flowchart showing a control method of the fourth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

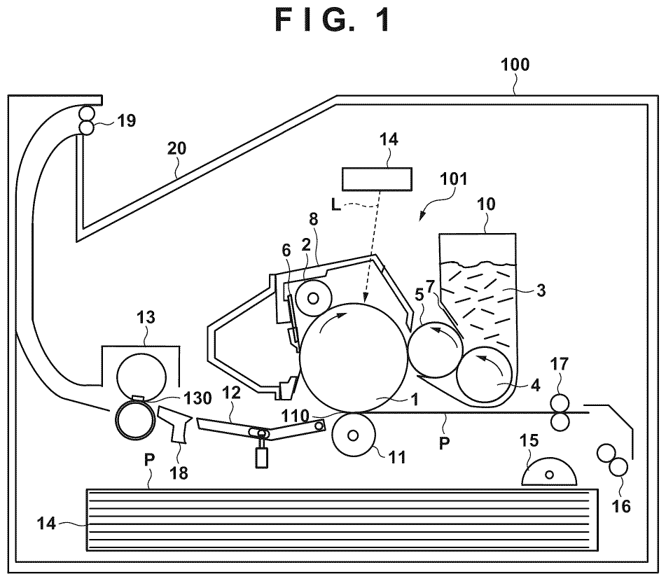

An image forming device 100 according to the present disclosure will be described in detail with reference to FIGS. 1 to 3. However, unless otherwise specified, the dimensions, materials, shapes, relative arrangements thereof, and the like of the components described in the present embodiment are not intended to limit the scope of the present disclosure only to them.

### 1. Configuration of Image Forming Device

FIG. 1 is a vertical sectional view showing a schematic configuration of the image forming device 100. An image forming portion 101 includes a drum unit 8 and a developing unit 10. The drum unit 8 includes a photosensitive drum 1, a cleaning blade 6, and a charging roller 2. The photosensitive drum 1 is, for example, an image carrier having a photosensitive layer of an organic photoconductor (OPC). The photosensitive drum 1 is rotationally driven by a motor. The cleaning blade 6 is a cleaning member made of elastic rubber. The cleaning blade 6 cleans the surface of the photosensitive drum 1. The charging roller 2 is applied with a predetermined charging voltage, and charges the surface of the photosensitive drum 1.

An exposure device 9 is disposed above the image forming portion 101 and includes a light source that outputs a laser beam and a polygon mirror. The polygon mirror reflects the laser beam while rotating. By this, the laser beam is scanned on the photosensitive drum 1. That is, the exposure device 9 irradiates the photosensitive drum 1 with a laser beam L modulated based on image data to form an electrostatic latent image on the surface of the photosensitive drum 1. The light source is a semiconductor laser, a light emitting diode, or the like.

The developing unit 10 includes a developing roller 5, a toner 3, a toner applying roller 4, and a toner applying blade 7. The toner 3 is a developer. The toner applying roller 4 stirs the toner 3 contained in a container of the developing unit 10 and applies the toner 3 to the developing roller 5. The toner applying blade 7 regulates the thickness of the layer of the toner 3 adhering to the developing roller 5. The developing roller 5 is a developing member that is applied with a developing voltage and adheres the toner 3 to the photosensitive drum 1. By this, the electrostatic latent image carried on the photosensitive drum 1 is developed, and a toner image is formed. The photosensitive drum 1 conveys the toner image to a transfer nip 110.

A feeding cassette 14 is a stocker that can contain a plurality of the recording materials P. A manual feeding tray may be adopted together with the feeding cassette 14. A feeding roller 15 is a semicircular roller that picks up the recording material P from the feeding cassette 14 to feed out the recording material P to a conveyance path. A separation roller pair 16 is a conveyance roller pair that separates one recording material P from the plurality of recording materials P and conveys the recording material P. A registration roller 17 is a conveyance roller pair that corrects the orientation of the recording material P and adjusts the feeding timing of the recording material P with respect to the transfer nip 110.

A transfer roller 11 is a transfer member disposed so as to face the photosensitive drum 1. The transfer roller 11 forms the transfer nip 110 in cooperation with the photosensitive drum 1. The recording material P passes through the transfer nip 110. When the transfer roller 11 is applied with a transfer voltage, the toner image is transferred from the photosensitive drum 1 to the recording material P. The photosensitive drum 1 and the transfer roller 11 convey the recording material P while nipping the recording material P. In this manner, the transfer roller 11 transfers the developer on the photosensitive drum 1 to the recording material P.

A conveyance guide 12 and an entrance guide 18 are disposed between the transfer roller 11 and a fixing device 13 in the conveyance direction of the recording material P. The conveyance guide 12 and the entrance guide 18 guide the lower surface of the recording material P so as to direct, toward the fixing nip 130, the recording material P which has passed through the transfer nip 110. By applying heat and pressure to the recording material P passing through the fixing nip 130, the fixing device 13 fixes the toner image on the recording material P. A discharge roller 19 discharges the recording material P onto a discharge tray 20.

### 2. Structure of Fixing Device

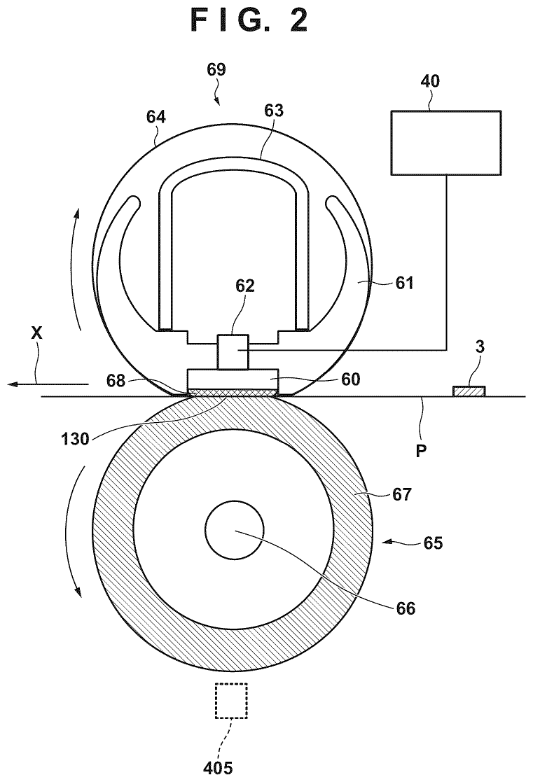

FIG. 2 shows the fixing device 13. A heating belt 64 provided in a heating unit 69 is a heating member or a heating rotating body made of an endless belt. A pressure roller 65 is a roller-shaped pressure member or a pressing rotary body. A heater 60 is a heating member disposed so as to slide with respect to an inner peripheral surface of the heating belt 64.

The heating belt 64 is a barrel formed of a plurality of layers and having heat resistance and elasticity. The base layer includes, for example, a thin heat-resistant resin such as polyimide or a metal such as stainless steel. A release layer may be formed on the surface of the heating belt 64. The release layer includes, for example, a heat-resistant resin having excellent releasability such as tetrafluoroethylene-perfluoroalkyl vinyl ether copolymer (PFA). This suppresses the toner from adhering to the heating belt 64, and a sheet P is easily separated from the heating belt 64. An elastic layer may be disposed between the base layer and the release layer. The elastic layer includes, for example, a heat-resistant rubber such as a silicone rubber.

The pressure roller 65 includes a core metal 66 and an elastic layer 67. The core metal 66 is made of, for example, iron or aluminum. The elastic layer 67 is, for example, a rubber layer made of silicone rubber or the like. In this manner, the pressure roller 65 includes the rubber layer that forms the nip portion (fixing nip 130) together with the heater 60 via the heating belt 64. The heater 60 is provided on the inner surface side of the heating belt 64 and is held by a holding member 61. The holding member 61 is held by a stay member 63 of metal. The stay member 63 presses the heater 60 against the inner peripheral surface of the heating belt 64 via the holding member 61. A lubricant 68 may be applied between the heater 60 and the heating belt 64. The lubricant 68 may be, for example, a mixture of fluororesin such as polytetrafluoroethylene and fluoro oil such as perfluoropolyether. This reduces sliding resistance between the heater 60 and the heating belt 64.

A pressure force is applied between the stay member 63 and the pressure roller 65 by a pressure mechanism not shown (e.g., spring). The pressure roller 65 is pressurized against the heater 60 via the heating belt 64, whereby the fixing nip 130 is formed. The pressure roller 65 rotates counterclockwise, whereby the heating belt 64 also rotates clockwise following the pressure roller 65. The sheet P passes through the fixing nip 130, whereby a toner image T is fixed on the sheet P.

The heater 60 is, for example, a ceramic heater including a ceramic substrate and a heating element provided thereon. A thermistor 62 is a temperature detection element disposed so as to abut on the heater 60. A controller 40 controls electric power supplied to the heater 60 based on a detection result of the thermistor 62. This maintains the temperature of the heating belt 64 at a target temperature.

Optionally, a temperature sensor 405 for measuring the temperature of the pressure roller 65 may be disposed near a peripheral surface of the pressure roller 65. The temperature sensor 405 may be a contact type sensor that is in contact with the peripheral surface of the pressure roller 65 to measure the temperature of the pressure roller 65, or may be a contactless type sensor that is not in contact with the peripheral surface of the pressure roller 65 and measures the temperature of the pressure roller 65.

### 3. Conveyance Guide

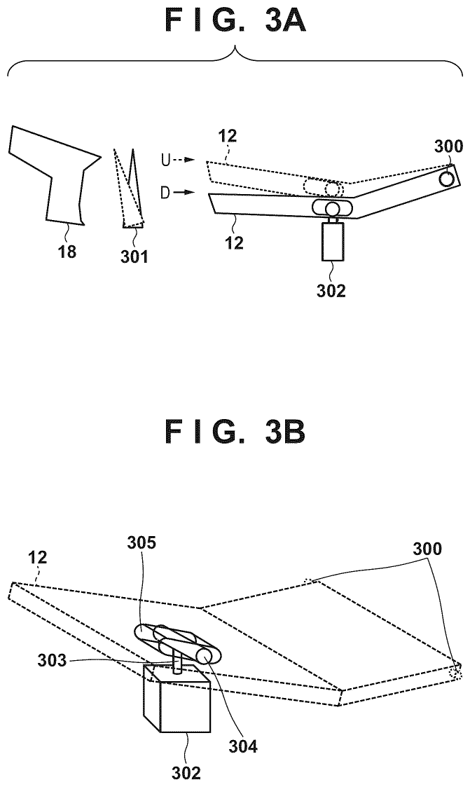

FIG. 3A is a schematic sectional view showing a structure of the conveyance guide 12 functioning as a guiding member that conveys the recording material P. One end of the conveyance guide 12 is axially supported by the image forming portion 101 rotatably by a rotation shaft 300. A plunger 302, which is an example of a moving member for moving the conveyance guide 12, is attached to a central portion of the conveyance guide 12. As indicated by a broken line in FIG. 3A, when the plunger 302 extends, the conveyance guide 12 moves to a first position U (home position). When the plunger 302 shrinks, the conveyance guide 12 moves to a second position D. The second position D is below the first position U. In this manner, the plunger 302 moves the conveyance guide 12 to the first position U or the second position D positioned below the first position U.

The temperature state of the pressure roller 65 varies. Here, in order to simplify the description, a low temperature state and a high temperature state divided by a threshold Tth will be described. The low temperature state is a state in which the pressure roller 65 is cold. The high temperature state is a state in which the pressure roller 65 is warmed. When the pressure roller 65 repeats fixing of the toner image, the temperature state transitions from the low temperature state to the high temperature state. In the high temperature state, the elastic layer 67 of the pressure roller 65 expands, and the diameter of the pressure roller 65 increases. This increases the conveyance speed of the recording material P in the fixing nip 130.

In this manner, the diameter of the pressure roller 65 increases as the temperature of the pressure roller 65 rises, and the diameter of the pressure roller 65 decreases as the temperature of the pressure roller 65 decreases. Therefore, a conveyance speed vf in the fixing nip 130 increases as the temperature of the pressure roller 65 rises, and the conveyance speed vf in the fixing nip 130 decreases as the temperature of the pressure roller 65 decreases. On the other hand, the conveyance speed in the transfer nip 110 is controlled to be substantially constant.

A conveyance speed vt of the recording material P in the transfer nip 110 is designed to be equal to a maximum conveyance speed vf_max in the fixing nip 130. The maximum conveyance speed vf_max is the conveyance speed of the recording material P in the fixing nip 130 when the pressure roller 65 is in a high temperature state. Adopting such a conveyance speed vt reduces disturbance of the toner image. That is, as the temperature of the pressure roller 65 rises from the low temperature state toward the high temperature state, the disturbance of the toner image is reduced.

On the other hand, when the pressure roller 65 is in a low temperature state, the conveyance speed vf of the recording material P at the fixing nip 130 is slower than the conveyance speed vt at the transfer nip 110. Therefore, the recording material P is bent. Here, the recording material P is bent such that a part of the recording material P protrudes downward. When a part of the recording material P is bent downward, a part of the recording material P comes into contact with the conveyance guide 12, but the conveyance guide 12 may fail to receive the part thereof. In this case, the recording material P is warped so that a part of the recording material P protrudes upward. As a result, the toner image is rubbed against an internal member such as the drum unit 8 and disturbed.

Therefore, when a condition that bending occurs in the recording material P present between the transfer nip 110 and the fixing nip 130 is satisfied, the plunger 302 shrinks. By this, the conveyance guide 12 is lowered to the second position D, and the bending of the recording material P can be released downward. As a result, the disturbance of the toner image is reduced.

As shown in FIG. 3A, a sheet sensor 301 may be provided downstream of the conveyance guide 12 and upstream of the entrance guide 18 in the conveyance direction of the recording material P. The sheet sensor 301 detects a timing at which a leading edge of the recording material P is passed to the fixing device 13. According to FIG. 3A, the sheet sensor 301 is disposed so as to detect that the recording material P has arrived at the entrance guide 18. However, the sheet sensor 301 may be disposed anywhere in the conveyance path extending from the feeding cassette 14 to the entrance guide 18. The distance from the sheet sensor 301 to the entrance guide 18 and the process speed (conveyance speed) are known. That is, the conveyance time from the sheet sensor 301 to the entrance guide 18 is known. Hence, by adding a predetermined conveyance time to the timing at which the sheet sensor 301 detects the leading edge of the recording material P, the timing at which the recording material P arrives at the entrance guide 18 is specified. In a case where the sheet sensor 301 is not provided, it may be detected that the leading edge of the recording material P is passed to the fixing device 13 based on the elapsed time from the timing at which the conveyance of the recording material P is started.

FIG. 3B shows a connecting portion between the conveyance guide 12 and the plunger 302. The conveyance guide 12 has a conveyance surface (upper surface) that conveys the recording material P and a non-conveyance surface (lower surface) that does not convey the recording material P. An elongated hole 305 is provided between the conveyance surface (upper surface) and the non-conveyance surface. The thickness of the elongated hole 305 is smaller than the thickness of the conveyance guide 12. That is, the elongated hole 305 is provided inside the conveyance guide 12. The width of the elongated hole 305 in a width direction orthogonal to the conveyance direction of the recording material P may be narrower than the width of the conveyance guide 12. The plunger 302 may include, for example, a solenoid, a spring, and a T-shaped arm 303. The T-shaped arm 303 may be biased upward by a spring. In this case, when electric power is supplied to the solenoid, the solenoid pulls the T-shaped arm 303 downward. Conversely, the T-shaped arm 303 may be biased downward by a spring. In this case, when electric power is supplied to the solenoid, the solenoid pushes the T-shaped arm 303 upward. In this manner, the plunger 302 can move the T-shaped arm 303 in the upward direction and the downward direction.

The T-shaped arm 303 and the elongated hole 305 allow the position of the conveyance guide 12 to move up and down by the plunger 302. The T-shaped arm 303 is attached to the plunger 302. Both ends 304 of the T-shaped arm 303 are fitted into the elongated hole 305. Then, when the plunger 302 raises the T-shaped arm 303, both ends 304 slide to the right in the elongated hole 305 in FIG. 3A. By this, the conveyance guide 12 moves to the first position U. When the plunger 302 lowers the T-shaped arm 303, both ends 304 slide to the left in the elongated hole 305 in FIG. 3A. By this, the conveyance guide 12 moves to the second position D.

In this manner, since the conveyance guide 12 is axially supported rotatably by the rotation shaft 300, the conveyance guide 12 can rock. The T-shaped arm 303 and the elongated hole 305 are used to convert up/down movement of the plunger 302 into rocking of the conveyance guide 12.

### 4. Controller

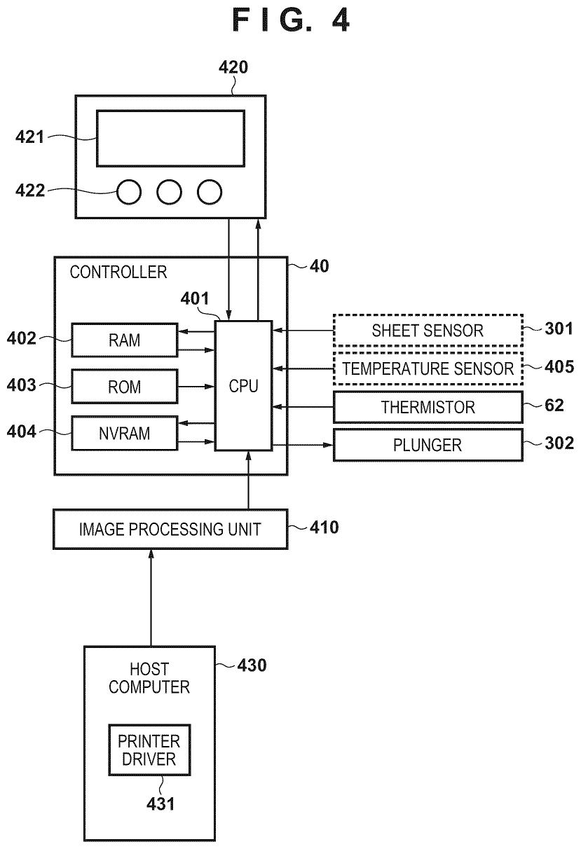

FIG. 4 shows the details of the controller 40. The controller 40 is capable of communicating with an image processing unit 410. The controller 40 controls the image forming portion 101 based on an instruction received from the image processing unit 410.

A CPU 401 is connected to the exposure device 9, a RAM 402, a ROM 403, an NVRAM 404, and the like. The CPU 401 is connected to the sheet sensor 301. The CPU 401 may be connected to the temperature sensor 405 for measuring the temperature of the pressure roller 65. The temperature sensor 405 is optional, and the thermistor 62 may be adopted instead of the temperature sensor 405. RAM is an abbreviation for random access memory. ROM is an abbreviation for read-only memory. NVRAM is an abbreviation for non-volatile random access memory. The ROM 403 stores a control program and various data for the CPU 401 to control the image forming device 100. The RAM 402 temporarily stores various data such as data deployed from the ROM 403. The NVRAM 404 is a storage device that can hold recorded content even when the power supply of the image forming device 100 is interrupted.

The CPU 401 is connected to an operation panel 35. The operation panel 35 includes a display device 421 and an input device 422. The display device 421 is a liquid crystal display or the like that displays various types of information to a user. The input device 422 includes a hardware key or a touch sensor that detects settings (example: basis weight and length of the recording material P) and an instruction that are input by the user.

### 5. Image Processing Unit

The image forming device 100 is connected to a host computer 430 in a stand-alone manner or via a network. An image or the like is created by application software or the like in the host computer 430. A printer driver 431 creates print information (printing information) including the image and transmits the print information to the image processing unit 410. This print information includes a drawing command such as characters, graphics, and images described in a page description language (PDL). The print information may include information regarding the basis weight of the recording material P and information regarding the size of the recording material P.

The image processing unit 410 is an integrated circuit provided outside the CPU 401, but may be mounted inside the CPU 401. The image processing unit 410 receives print information from the host computer 430 and rasterizes the print information. By this, image data in bitmap format matching the resolution of the image forming device 100 and the size of a print image is generated. The image processing unit 410 analyzes the image data, applies, to the image data, gradation processing (e.g., dither) corresponding to the analysis result, and generates image data for output. The image processing unit 410 transmits image data to the controller 40 at a predetermined timing.

### 6. Functions Implemented by CPU

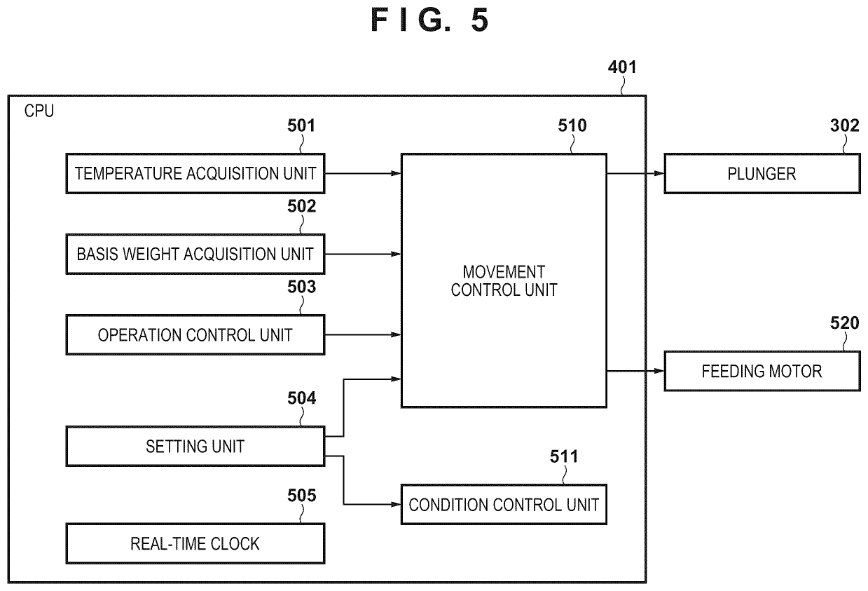

FIG. 5 shows a plurality of functions implemented by the CPU 401 executing the control program. However, these functions may be mounted on another integrated circuit independent of the CPU 401. A real-time clock 505 is a clock used for measuring time. Even when electric power supply to the image forming device 100 is interrupted, the real-time clock 505 can be continuously operated by being supplied with electric power from a built-in battery not shown.

A temperature acquisition unit 501 may acquire a temperature T of the pressure roller 65 by the temperature sensor 405, but this is merely an example. In order to omit the temperature sensor 405, the temperature acquisition unit 501 may acquire the temperature T of the pressure roller 65 based on the temperature detected by the thermistor 62. In this case, the temperature acquisition unit 501 calculates the temperature T using an up counter Cu for predicting the temperature rise degree of the pressure roller 65 and a down counter Cd for predicting the cooling degree of the pressure roller 65. Here, the up counter Cu and the down counter Cd may be variables stored in the RAM 402.

Upon starting an image forming operation, the temperature acquisition unit 501 acquires the temperature T of the pressure roller 65 at predetermined intervals (e.g., 0.5 seconds). In this manner, the temperature T is updated at predetermined intervals, but the temperature T actually compared with the predetermined threshold Tth is constantly a latest temperature T.

The heater 60 is heated from the start of conveyance of the recording material P until the recording material P passes through the fixing nip 130 (heating state). Thereafter, the heating of the heater 60 is stopped (non-heating state). When the conveyance of the next recording material P is started, the heater 60 executes heating again. Under such a premise, the up counter Cu and the down counter Cd are obtained at predetermined intervals (e.g., 0.5 seconds), and the temperature T of the pressure roller 65 is calculated based on them.

$$T = T b - C d + Cu \qquad Eq 1$$

Here, Tb is the temperature T calculated last time. For example, in a case where the temperature T acquired at an i-th acquisition timing is denoted as Ti, a temperature Tb is a temperature Ti−1 acquired at an (i−1)-th acquisition timing. In a case where the temperature Tb is smaller than the down counter Cd, the temperature acquisition unit 501 sets, to 0, the difference obtained by subtracting the down counter Cd from Tb. The up counter Cu can be calculated from the following equation, for example. An initial value T0 of the temperature T is Ttg. Here, Ttg is the temperature of the heater 60 detected by the thermistor 62.

$$Cu = T tg \times t\_h \times c \qquad Eq 2$$

t_h is a time (heating time) during which heat processing of the heater 60 is continued. C is a predetermined temperature rise coefficient. In a case where heating of the heater 60 has been executed for a predetermined interval (e.g., 0.5 seconds), the heating time t_h becomes equal to the predetermined interval. In a case where heating of the heater 60 has not been executed for a predetermined interval (e.g., 0.5 seconds), the heating time t_h becomes 0. The down counter Cd may be calculated from the following equation, for example.

$$Cd = t\_e \times d \qquad Eq 3$$

Here, t_e is a time (non-heating time) during which heating of the heater 60 is not executed. D is a predetermined cooling coefficient. In a case where heating of the heater 60 has been constantly executed for a predetermined interval (e.g., 0.5 seconds), the non-heating time t_e is 0. In a case where heating of the heater 60 has not been executed for a predetermined interval (e.g., 0.5 seconds), the non-heating time t_e becomes equal to the predetermined interval.

The heating time t_h and the non-heating time t_e are reset to 0 every time the temperature T is determined (i.e., at predetermined intervals). The heating time t_h and the non-heating time t_e are measured using the real-time clock 505.

In a case where the temperature T of the pressure roller 65 is larger than the predetermined threshold Tth, the bending generated in the recording material P can be small. Therefore, the movement control unit 510 controls the plunger 302 so that the conveyance guide 12 is positioned at the first position U. The movement control unit 510 controls the movement of the moving member (e.g., plunger 302).

In a case where the temperature T of the pressure roller 65 is smaller than the predetermined threshold Tth, the bending generated in the recording material P can be large. Therefore, the movement control unit 510 controls the plunger 302 so that the conveyance guide 12 is positioned at the second position D. Thereafter, the movement control unit 510 may control the plunger 302 so that the conveyance guide 12 moves from the second position D to the first position U. This makes it easier for the conveyance guide 12 to guide the next recording material P. That is, it becomes possible to receive the next recording material P. Therefore, the timing at which the conveyance guide 12 moves from the second position D to the first position U is before the leading edge of the next recording material P arrives at the conveyance guide 12.

In a case where the temperature T of the pressure roller 65 is smaller than the predetermined threshold Tth, the movement control unit 510 may control the plunger 302 so as to move the conveyance guide 12 to the second position D while the recording material P is being guided by the conveyance guide 12 at the first position U. When the conveyance guide 12 lowers to the second position D before the leading edge of the recording material P arrives at the entrance guide 18 or the fixing nip 130, the leading edge of the recording material P may collide with the entrance guide 18 and a jam may occur. Therefore, the conveyance guide 12 may lower to the second position D at the timing when the leading edge of the recording material P arrives at the entrance guide 18 or the fixing nip 130.

A basis weight acquisition unit 502 will be described in detail in the second embodiment. The basis weight acquisition unit 502 is a basis weight detection unit that acquires a basis weight G of the recording material P conveyed toward the heating unit 69. The basis weight acquisition unit 502 acquires the basis weight G based on information input from the input device 422 or the host computer 430 or information detected by a basis weight sensor not shown. The basis weight sensor includes a light emitting element that irradiates the recording material P with light and a light receiving element that receives light transmitted through the recording material P, and converts a transmission amount of light into the basis weight G. As the basis weight sensor, an ultrasonic sensor using ultrasound instead of light may be adopted. The ultrasonic sensor includes an ultrasonic oscillator that transmits ultrasound and an ultrasonic receiving element that receives ultrasound which has passed through the recording material P, and converts a transmission amount of ultrasound into the basis weight G. In a case where the basis weight G exceeds a threshold Gth, the movement control unit 510 may control the plunger 302 so that the conveyance guide 12 is positioned at the first position U. This is because the recording material P (e.g., thick paper) whose basis weight G exceeds the threshold Gth has small bending. Thereafter, the movement control unit 510 may control the plunger 302 so that the conveyance guide 12 moves from the second position D to the first position U. This makes it possible to receive the next recording material P. Therefore, the timing at which the conveyance guide 12 moves from the second position D to the first position U is likely before the leading edge of the next recording material P arrives at the conveyance guide 12.

In a case where the basis weight G does not exceed the threshold Gth, it is necessary to pay attention to bending of the recording material P. Therefore, the movement control unit 510 may control the plunger 302 so that the conveyance guide 12 is positioned at the second position D. In a case where the basis weight G does not exceed the threshold Gth, the movement control unit 510 may control the plunger 302 so as to move the conveyance guide 12 to the second position D while the recording material P is being guided by the conveyance guide 12 at the first position U. In this manner, when passing of the recording material P is completed, the conveyance guide 12 may be lowered to the second position D, and the disturbance of the toner image may be reduced.

A setting unit 504 will be described in detail in the third embodiment. The setting unit 504 sets the length (recording material length Le) of the recording material P in the conveyance direction. The setting unit 504 may acquire the recording material length Le based on information input from the input device 422 or the host computer 430 or information detected by a size sensor not shown. The size sensor may be installed in the feeding cassette 14 or may be installed in the conveyance path. A condition control unit 511 may change the condition of image formation based on the recording material length Le. For example, the condition control unit 511 may determine the target temperature set for the heater 60 based on the recording material length Le.

In a case where the recording material length Le is larger than a predetermined threshold Lth (e.g., long paper), it is necessary to pay attention to bending of the recording material P. Therefore, the movement control unit 510 may control the plunger 302 so that the conveyance guide 12 is positioned at the second position D. In a case where the recording material length Le is larger than the predetermined threshold Lth, the movement control unit 510 may control the plunger 302 so as to move the conveyance guide 12 to the second position D while the recording material P is being guided by the conveyance guide 12 at the first position U. In this manner, when passing of the recording material P is completed, the conveyance guide 12 may be lowered to the second position D, and the disturbance of the toner image may be reduced. Thereafter, the movement control unit 510 may control the plunger 302 so that the conveyance guide 12 moves from the second position D to the first position U. This makes it possible to receive the next recording material P. Therefore, the timing at which the conveyance guide 12 moves from the second position D to the first position U is likely before the leading edge of the next recording material P arrives at the conveyance guide 12.

In a case where the recording material length Le is smaller than the predetermined threshold Lth, bending of the recording material P is less likely to cause a problem. Therefore, the movement control unit 510 may control the plunger 302 so that the conveyance guide 12 is positioned at the first position U. However, even in a case where the recording material length Le is smaller than the predetermined threshold Lth, it is necessary to pay attention in a low temperature state.

The operation control unit 503 will be described in detail in Example 4. The operation control unit 503 may be mounted in the image processing unit 410 or may be the image processing unit 410 itself. The operation control unit 503 receives printing information of the recording material P and controls an image forming operation based on the print information. For example, in the printing information received by the operation control unit 503, a difference dI between a printing ratio IL of a first portion and a printing ratio IR of a second portion may be calculated. The first portion may be, for example, a left half of the recording material P. The second portion may be a right half of the recording material P.

In a case where an absolute value |dI| of the difference dI exceeds a predetermined threshold Ith, waving of the recording material P can become a problem. Therefore, the movement control unit 510 may control the plunger 302 so that the conveyance guide 12 is positioned at the second position D. In a case where the absolute value |dI| exceeds the predetermined threshold Ith, the movement control unit 510 may control the plunger 302 so as to move the conveyance guide 12 to the second position D while the recording material P is being guided by the conveyance guide 12 at the first position U. In this manner, when passing of the recording material P is completed, the conveyance guide 12 may be lowered to the second position D, and the disturbance of the toner image may be reduced. Thereafter, the movement control unit 510 may control the plunger 302 so that the conveyance guide 12 moves from the second position D to the first position U. This makes it possible to receive the next recording material P. Therefore, the timing at which the conveyance guide 12 moves from the second position D to the first position U is likely before the leading edge of the next recording material P arrives at the conveyance guide 12.

In a case where the absolute value |dI| does not exceed the predetermined threshold Ith, waving of the recording material P is likely to be small. Therefore, the movement control unit 510 may control the plunger 302 so that the conveyance guide 12 is positioned at the first position U. However, even in a case where the absolute value |dI| does not exceed the predetermined threshold Ith, it is necessary to pay attention in a low temperature state.

By controlling the operation timing of a feeding motor 520 that rotationally drives the feeding roller 15, the CPU 401 adjusts the distance (conveyance interval) between a trailing edge of the preceding recording material P and a leading edge of the subsequent recording material P fed next to the preceding recording material P. This conveyance interval is sometimes referred to as a sheet interval.

### 7. Image Forming Operation

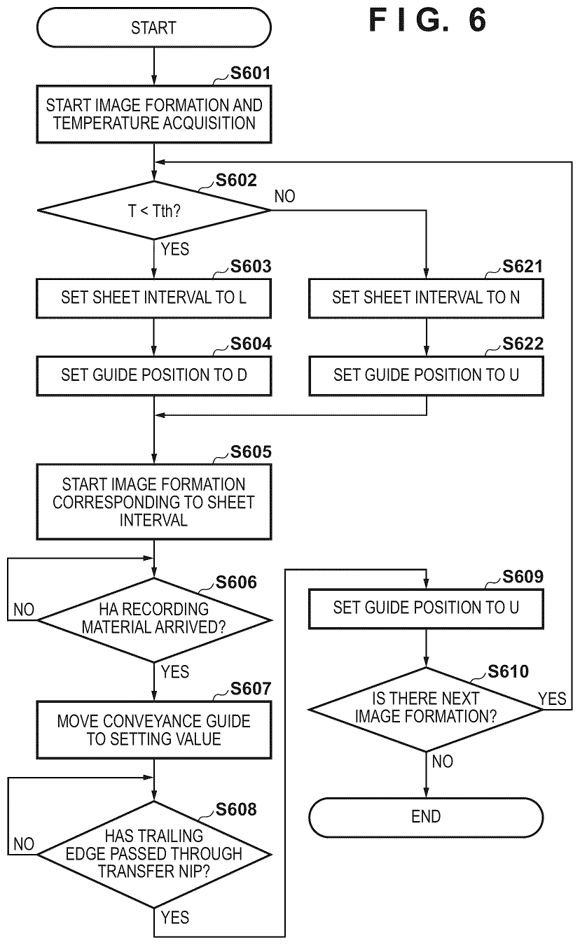

FIG. 6 is a flowchart showing an image forming operation. In the following description, it is assumed that the temperature T is updated at predetermined intervals when acquisition of the temperature T is started. That is, it is assumed that the acquisition operation of the temperature T is executed in parallel with the image forming operation. Before the image forming operation is started, the image forming device 100 is in a standby state. In the standby state, the conveyance guide 12 is at the first position U. Upon receiving an image forming instruction and printing information from the host computer 430, the CPU 401 starts the image forming operation.

In S601, the CPU 401 controls the image forming device 100 and starts image formation and temperature acquisition corresponding to the print information. The temperature acquisition is to acquire or detect the temperature T of the pressure roller 65.

In S602, the CPU 401 determines whether the pressure roller 65 is in a low temperature state or a high temperature state. For example, the low temperature state is a state in which the temperature T of the pressure roller 65 is less than the threshold Tth. The high temperature state is a state in which the temperature T of the pressure roller 65 exceeds the threshold Tth. If the state of the pressure roller 65 is the low temperature state, the CPU 401 proceeds from S602 to S603.

In S603, the CPU 401 sets a setting value of the sheet interval to L. In S604, the CPU 401 sets a setting value of a guide position to D. The setting value of the guide position is a setting value for determining the position of the conveyance guide 12 after the recording material P arrives at the entrance guide 18. The setting value of the sheet interval defines a conveyance interval (sheet interval distance) from the trailing edge of the preceding recording material P to the leading edge of the next recording material P when an image is continuously formed on the plurality of recording materials P. The CPU 401 adjusts the timing of image formation (timing at which the feeding roller 15 is driven by the feeding motor 520) in accordance with the setting value of the sheet interval.

On the other hand, if the state of the pressure roller 65 is determined to be the high temperature state in S602, the CPU 401 proceeds from S602 to S621. In S621, the CPU 401 sets the setting value of the sheet interval to N. Here, N is shorter than L. In S622, the CPU 401 sets the setting value of the guide position to U. Thereafter, the CPU 401 proceeds from S622 to S605.

In S605, the CPU 401 executes image formation so that the sheet interval indicated by the setting value of the sheet interval is achieved. Thereafter, the CPU 401 proceeds from S605 to S606.

In S606, the CPU 401 determines whether the leading edge of the recording material P has arrived at the entrance guide 18. When the recording material P arrives at the entrance guide 18, the CPU 401 proceeds from S606 to S607.

In S607, the CPU 401 controls the plunger 302, and operates the plunger 302 in accordance with the setting value of the guide position to move the conveyance guide 12 to the setting value. The home position of the conveyance guide 12 is the first position U. Therefore, in a case where the setting value is U, the conveyance guide 12 remains at the first position U. In a case where the setting value is D, the conveyance guide 12 moves from the first position U to the second position D. In this manner, while the recording material P is being conveyed by the conveyance guide 12, the conveyance guide 12 moves from the first position U to the second position D.

In S608, the CPU 401 determines whether the trailing edge of the recording material P has passed through the transfer nip 110. For example, the CPU 401 determines that the trailing edge of the recording material P has passed through the transfer nip 110 when a predetermined time has elapsed from the time when the conveyance of the recording material P is started by the feeding roller 15. When the trailing edge of the recording material P passes through the transfer nip 110, the CPU 401 proceeds from S608 to S609.

In S609, the CPU 401 controls the plunger 302 and sets the position of the conveyance guide 12 to U. By this, the conveyance guide 12 moves to the first position U, which is a default position. In a case where the conveyance guide 12 already remains at the first position U, S609 is skipped.

In S610, the CPU 401 determines whether there is a next image formation operation. If there is a next image formation operation, the CPU 401 proceeds from S610 to S602. If there is no next image formation, the CPU 401 proceeds to S612.

In this manner, according to the first embodiment, a fixing device of a new form in which the known technique is developed is provided.

As described above, the sheet interval L is larger than the sheet interval N. By making the sheet interval distance as small as possible, the number of images (throughput) formed per unit time increases. In the low temperature state, the conveyance guide 12 lowers to the second position D. If the leading edge of the next recording material P enters the conveyance guide 12 while the conveyance guide 12 is returning to the first position U, various problems can arise. For example, when the recording material P comes into contact with the conveyance guide 12 that is rising, a shock derived from the contact is transmitted to the recording material P. As a result, the toner image on the recording material P may be disturbed.

Therefore, in a case where the conveyance guide 12 is at the second position D, it is required that the next recording material P arrives at the conveyance guide 12 after the conveyance guide 12 reliably returns to the first position U. Therefore, according to the first embodiment, the CPU 401 sets the sheet interval to the sheet interval L that is relatively large.

On the other hand, in the high temperature state, the conveyance guide 12 is maintained at the first position U. Therefore, image formation of the next recording material P is executed in the original sheet interval N. That is, a higher throughput is achieved while a high-quality image is obtained. Therefore, the sheet interval of the recording material P set in a case where the temperature T of the pressure roller 65 is smaller than the predetermined threshold Tth is larger than the sheet interval of the recording material P set in a case where the temperature T of the pressure roller 65 is larger than the predetermined threshold Tth.

According to the first embodiment, there is a case where the temperature T of the pressure roller 65 is smaller than the predetermined threshold Tth. In this case, after the movement control unit 510 controls the plunger 302 so that the conveyance guide 12 is positioned at the second position D, the movement control unit 510 may control the plunger 302 so that the conveyance guide 12 moves from the second position D to the first position U.

### Second Embodiment

In the second embodiment, the position of the conveyance guide 12 is controlled according to the basis weight G of the recording material P. This provides a fixing device of a new form in which the known technique is developed. In the second embodiment, components having similar configuration and action to those of the first embodiment are denoted by identical reference signs, and the description thereof will be omitted.

Paper usually used as the recording material P is called plain paper. On the other hand, the recording material P having a basis weight larger than the basis weight of plain paper may be called thick paper. Since the rigidity of thick paper is higher than the rigidity of plain paper, the thick paper is less likely to be bent. That is, even if there is a difference between the conveyance speed in the transfer nip 110 and the conveyance speed in the fixing nip 130, the thick paper is less likely to be bent. Therefore, a difference in conveyance speed is absorbed by slight sliding of thick paper at either the transfer nip 110 or the fixing nip 130. Hence, in a case where thick paper is used, the position of the conveyance guide 12 need not be changed to the second position D.

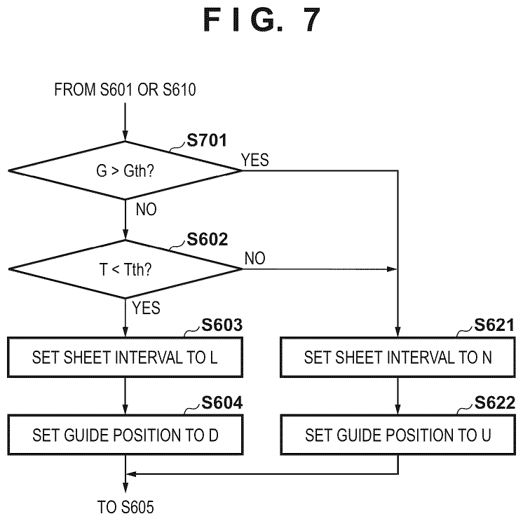

FIG. 7 is a flowchart of the second embodiment. As shown in FIG. 7, S701 is added between S601 and S602. In S701, the CPU 401 (movement control unit 510) determines whether the basis weight G exceeds the threshold Gth. The movement control unit 510 acquires the basis weight G from the basis weight acquisition unit 502. If the basis weight G does not exceed the threshold Gth, the CPU 401 proceeds from S701 to S602. That is, the conveyance guide 12 is controlled according to the temperature T of the pressure roller 65.

On the other hand, in a case where the basis weight G exceeds the threshold Gth, the CPU 401 proceeds from S701 to S621. That is, in a case where the recording material P is thick paper, the sheet interval is set to N, and the guide position is set to the first position U.

This provides a fixing device of a new form in which the known technique is developed. According to the second embodiment, the conveyance guide 12 no longer moves unnecessarily. As a result, the operating noise of the conveyance guide 12 is reduced. The occurrence of unnecessary shock accompanying the movement of the conveyance guide 12 is also reduced.

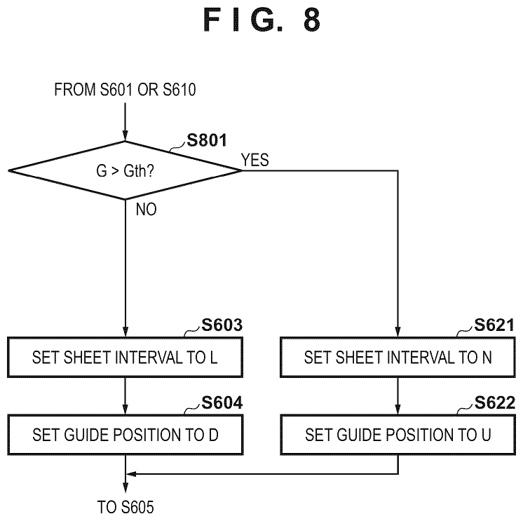

FIG. 8 is another flowchart of the second embodiment. As compared with FIG. 7, S602 is omitted in FIG. 8. That is, the temperature T of the pressure roller 65 need not be taken into consideration.

In S801, the CPU 401 (movement control unit 510) determines whether the basis weight G exceeds the threshold Gth. The movement control unit 510 acquires the basis weight G from the basis weight acquisition unit 502. If the basis weight G does not exceed the threshold Gth, the CPU 401 proceeds from S801 to S603. That is, in a case where the recording material P is plain paper or the like, the sheet interval is set to L, and the guide position is set to the second position D.

On the other hand, in a case where the basis weight G exceeds the threshold Gth, the CPU 401 proceeds from S801 to S621. That is, in a case where the recording material P is thick paper, the sheet interval is set to N, and the guide position is set to the first position U.

According to the second embodiment, in a case where the basis weight G of the recording material P detected by the basis weight acquisition unit 502 exceeds the threshold Gth, the movement control unit 510 may control the plunger 302 so that the conveyance guide 12 is positioned at the first position U. In a case where the basis weight G of the recording material P detected by the basis weight acquisition unit 502 does not exceed the threshold Gth, the movement control unit 510 may control the plunger 302 so that the conveyance guide 12 is positioned at the second position D. This may provide a fixing device of a new form in which the known technique is developed. There is a case where the basis weight G of the recording material P detected by the basis weight acquisition unit 502 does not exceed the threshold Gth. In this case, the movement control unit 510 may control the plunger 302 so as to move the conveyance guide 12 to the second position D while the recording material P is being guided by the conveyance guide 12 at the first position U. In a case where the basis weight G of the recording material P detected by the basis weight acquisition unit 502 does not exceed the threshold Gth, after the movement control unit 510 controls the plunger 302 so that the conveyance guide 12 is positioned at the second position D, the movement control unit 510 may control the plunger 302 so that the conveyance guide 12 moves from the second position D to the first position U.

### Third Embodiment

In the third embodiment, the position of the conveyance guide 12 is controlled according to the recording material length Le. This provides a fixing device of a new form in which the known technique is developed. In the third embodiment, components having similar configuration and action to those of the first embodiment or the second embodiment are denoted by identical reference signs, and the description thereof will be omitted. In the third embodiment, in order to prevent the recording material P from being pulled between the fixing nip 130 and the transfer nip 110, the conveyance speed of the transfer roller 11 is set to be higher than the conveyance speed of the pressure roller 65.

As the recording material P, A4 size paper and Letter size paper are often used. On the other hand, the recording material P having a Legal size, which is relatively longer than these or the recording material P having a long size that is specially prepared may be used.

Ideally, the conveyance speed vf_max of the recording material P in the fixing nip 130 when the pressure roller 65 is in a high temperature state is equal to the conveyance speed vt in the transfer nip 110. However, each member involved in conveyance of the recording material P has a tolerance. Therefore, the image forming device 100 is designed such that vt becomes vf_max or more even in consideration of those tolerances. As a result, the recording material P is less likely to be pulled between the fixing nip 130 and the transfer nip 110.

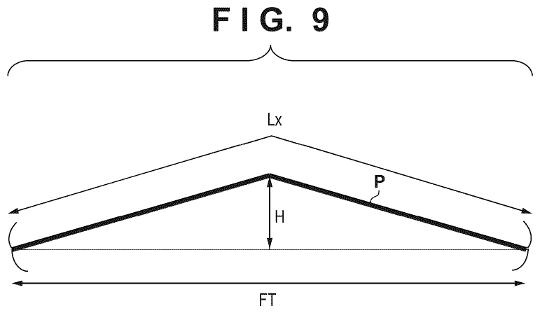

FIG. 9 shows a distance FT between the fixing nip 130 and the transfer nip 110. In FIG. 9, since the recording material P is bent, a bending height H is generated.

For example, it is assumed that the distance FT is 150 mm and the pressure roller 65 is in a high temperature state. By the tolerance described above, vt/vf_max is assumed to be 1.005. The length (remaining length Lx) of the recording material P remaining between the fixing nip 130 and the transfer nip 110 immediately before the trailing edge of the recording material P passes through the transfer nip 110 is as follows.

$$A 4 size ( L = 297 mm ) : Lx = 150.645 mm$$

$$Legal size ( L = 355.6 mm ) : Lx = 15 \; 1.0 \; 28 mm$$

The distance FT is 150 mm, and the remaining length Lx of the A4 size is 150.645 mm. Hence, the bending height H is 7 mm. The bending height H for the Legal size is 8.8 mm. If a further longer recording material P is used, the bending height H also increases.

In order to downsize the image forming device 100, the A4 size and the Letter size are assumed as the size of the recording material P used by the user. Furthermore, a conveyance path of the recording material P is also designed to be short. Therefore, even if the pressure roller 65 is in a high temperature state and there is a maximum assumed tolerance, the conveyance path has only a margin to the extent that the recording material P is not rubbed against an internal member of the image forming device 100. Here, the internal member is the photosensitive drum 1 or the like.

Therefore, if the recording material P having a length exceeding the Legal size is used, the recording material P can rub against the internal member. In particular, assuming that the pressure roller 65 is in a high temperature state, the recording material P can rub against the internal member due to bending of the recording material P. Therefore, in the third embodiment, the recording material length Le is considered.

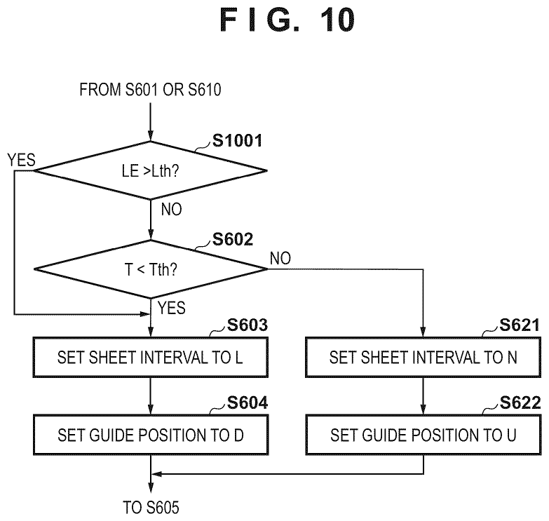

FIG. 10 is a flowchart of the third embodiment. S1001 is added between S601 and S602.

In S1001, the CPU 401 (movement control unit 510) acquires the recording material length Le set by the setting unit 504, and determines whether the recording material length Le exceeds the threshold Lth. In a case where the recording material length Le exceeds the threshold Lth, the CPU 401 proceeds from S1001 to S603. That is, in a case where the recording material length Le exceeds the threshold Lth, the sheet interval is set to L, and the guide position is set to the second position D.

On the other hand, in a case where the recording material length Le does not exceed the threshold Lth, the CPU 401 proceeds from S1001 to S602. That is, the sheet interval and the guide position are determined in consideration of the temperature T of the pressure roller 65.

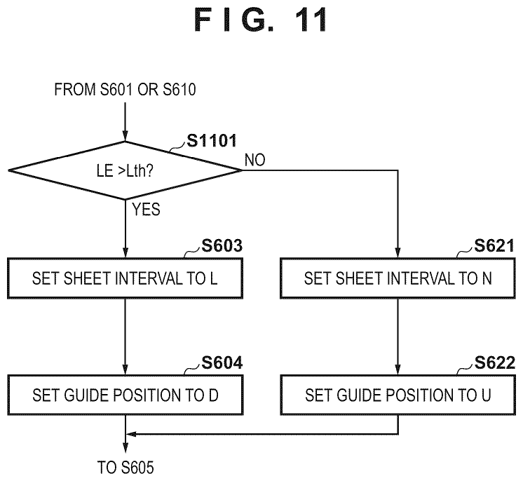

FIG. 11 is another flowchart of the third embodiment. As compared with FIG. 10, S602 is omitted in FIG. 11. That is, the temperature T of the pressure roller 65 need not be taken into consideration.

In S1101, the CPU 401 (movement control unit 510) acquires the recording material length Le set by the setting unit 504, and determines whether the recording material length Le exceeds the threshold Lth. In a case where the recording material length Le exceeds the threshold Lth, the CPU 401 proceeds from S1101 to S603. That is, in a case where the recording material length Le exceeds the threshold Lth, the sheet interval is set to L, and the guide position is set to the second position D.

On the other hand, in a case where the recording material length Le does not exceed the threshold Lth, the CPU 401 proceeds from S1101 to S621. That is, in a case where the recording material length Le does not exceed the threshold Lth, the sheet interval is set to N, and the guide position is set to the first position U.

In this manner, according to the third embodiment, a fixing device of a new form in which the known technique is developed is provided. For example, in a case where the recording material P is long paper, the conveyance guide 12 moves to the second position D regardless of the temperature T of the pressure roller 65. This is likely to absorb the bending of the recording material P, and the recording material P is unlikely to rub against the internal member. As a result, it is possible to achieve both downsizing of the image forming device 100 and coping with the long paper of the recording material P.

Specifically, in a case where the length Le set by the setting unit 504 is larger than the predetermined threshold Lth, the movement control unit 510 may control the plunger 302 so that the conveyance guide 12 is positioned at the second position D. In a case where the length Le is smaller than the threshold Lth, the movement control unit 510 may control the plunger 302 so that the conveyance guide 12 is positioned at the first position U. In a case where the length Le is larger than the threshold Lth, the movement control unit 510 may control the plunger 302 so as to move the conveyance guide 12 to the second position D while the recording material P is being guided by the conveyance guide 12 at the first position U. In a case where the length Le is larger than the threshold Lth, after the movement control unit 510 controls the plunger 302 so that the conveyance guide 12 is positioned at the second position D, the movement control unit 510 may control the plunger 302 so that the conveyance guide 12 moves from the second position D to the first position U.

### Fourth Embodiment

In the fourth embodiment, the position of the conveyance guide 12 is controlled according to the printing ratio of the image. This provides a fixing device of a new form in which the known technique is developed. In the fourth embodiment, components having similar configuration and action to those of any of the first to third embodiments are denoted by identical reference signs, and the description thereof will be omitted.

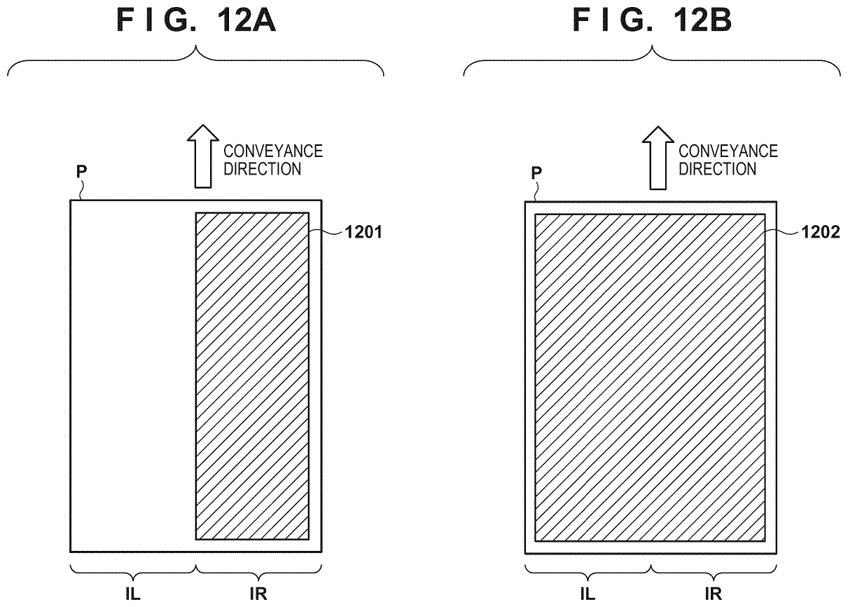

FIG. 12A shows an example in which an image 1201 is formed on the right half of the surface of the recording material P and no image is formed on the left half of the surface. The right half of the surface is a portion (first portion) of the recording material P included from the center to one end of the recording material P in an axial direction of the photosensitive drum 1. The direction parallel to the axial direction of the photosensitive drum 1 may be called a main scanning direction. A direction parallel to the conveyance direction of the recording material P may be called a sub-scanning direction. The left half of the surface is a portion (second portion) of the recording material P included from the center to the other end of the recording material P in the axial direction. The left half of the surface may be called the first portion, and the right half of the surface may be called the second portion.

FIG. 12B shows an example in which an image 1202 is formed on almost the entire surface of the recording material P. IL represents a printing ratio on the left half of the surface of the recording material P. IR represents a printing ratio on the right half of the surface of the recording material P. Here, the printing ratio is the area of the image or a toner application amount with respect to the area of the recording material P.

In the case shown in FIG. 12A, the right half of the surface on which the toner image exists slides with respect to the fixing nip 130, and the left half of the surface on which the toner image does not exist does not slide. Therefore, a difference may occur between the conveyance speed of the recording material P on the right half of the surface and the conveyance speed of the recording material P on the left half of the surface, and a left-right difference may occur in traveling of the recording material P. Specifically, the left half of the surface is warped downward, and the right half of the surface is warped upward. This causes the recording material P to be waved. As a result, the recording material P may rub against the internal member, and the toner image may be disturbed.

On the other hand, in the case of FIG. 12B, the printing ratio IR of the right half of the surface and the printing ratio IL of the left half of the surface are substantially equal to each other. Therefore, a conveyance speed difference does not occur, and the recording material P is less likely to wave.

Therefore, in the fourth embodiment, the position of the conveyance guide 12 is controlled in consideration of the printing ratio IR and the printing ratio IL.

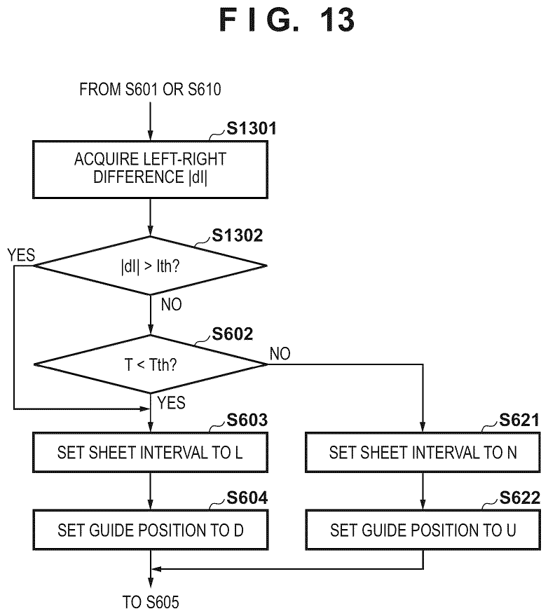

FIG. 13 is a flowchart of the fourth embodiment. S1301 and S1302 are added between S601 and S602.

In S1301, the CPU 401 (movement control unit 510 or operation control unit 503) acquires the left-right difference dI of the printing ratio based on the printing information input from the host computer 430 to the image processing unit 410. Here, the absolute value dI is used as the left-right difference |dI|.

$$d I = IR - IL \qquad Eq 4$$

In this manner, the calculation of the left-right difference dI may be executed in the image processing unit 410 or may be executed in the CPU 401.

In S1302, the CPU 401 (movement control unit 510) determines whether the absolute value |dI| of the left-right difference dI exceeds the threshold Ith. The threshold Ith is, for example, 0.8. In a case where the absolute value |dI| exceeds the threshold Ith, the CPU 401 proceeds from S1302 to S603. That is, in a case where the absolute value |dI| exceeds the threshold Ith, the sheet interval is set to L, and the conveyance guide 12 is controlled to the second position D.

On the other hand, in a case where the absolute value |dI| does not exceed the threshold Ith, the CPU 401 proceeds from S1302 to S602. That is, the sheet interval and the guide position are determined in consideration of the temperature T of the pressure roller 65.

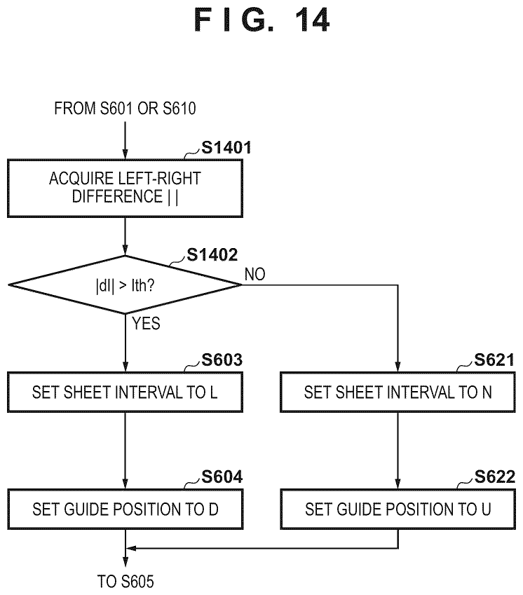

FIG. 14 shows another flowchart of the fourth embodiment. As compared with FIG. 13, S602 is omitted in FIG. 14. That is, the temperature T of the pressure roller 65 need not be taken into consideration.

In S1401, the CPU 401 (movement control unit 510 or operation control unit 503) acquires the left-right difference dI of the printing ratio based on the printing information input from the host computer 430 to the image processing unit 410. Here, the absolute value dI is used as the left-right difference |dI|.

In S1402, the CPU 401 (movement control unit 510) determines whether the absolute value |dI| of the left-right difference dI exceeds the threshold Ith. In a case where the absolute value |dI| exceeds the threshold Ith, the CPU 401 proceeds from S1402 to S603. That is, in a case where the absolute value |dI| exceeds the threshold Ith, the sheet interval is set to L, and the conveyance guide 12 is controlled to the second position D.

On the other hand, in a case where the absolute value |dI| does not exceed the threshold Ith, the CPU 401 proceeds from S1402 to S621. That is, in a case where the absolute value |dI| does not exceed the threshold Ith, the sheet interval is set to N, and the conveyance guide 12 is controlled to the first position U.

In this manner, in the fourth embodiment, the position of the conveyance guide 12 is controlled according to the printing ratios IR and IL of the image. This provides a fixing device of a new form in which the known technique is developed.

For example, in a case where it is predicted that waving occurs in the recording material P due to an image printed on the recording material P, the position of the conveyance guide 12 is set to the second position D. By this, since the conveyance guide 12 provides space for accommodating the waving of the recording material P, the recording material P is less likely to rub against the internal member.

In this manner, in the printing information of the recording material P, in a case where the absolute value of the difference between the printing ratio of the first portion and the printing ratio of the second portion exceeds a predetermined threshold, the movement control unit 510 may control the plunger 302 so that the conveyance guide 12 is positioned at the second position D. In a case where the absolute value of the difference between the printing ratio of the first portion and the printing ratio of the second portion does not exceed a predetermined threshold, the movement control unit 510 may control the plunger 302 so that the conveyance guide 12 is positioned at the first position U. In a case where the absolute value of the difference between the printing ratio of the first portion and the printing ratio of the second portion exceeds a predetermined threshold, the movement control unit 510 may control the plunger 302 so as to move the conveyance guide 12 to the second position D while the recording material P is being guided by the conveyance guide 12 at the first position U. In a case where the absolute value of the difference between the printing ratio of the first portion and the printing ratio of the second portion exceeds a predetermined threshold, after the movement control unit 510 controls the plunger 302 so that the conveyance guide 12 is positioned at the second position D, the movement control unit 510 may control the plunger 302 so that the conveyance guide 12 moves from the second position D to the first position U.

In the first to fourth embodiments described above, the threshold Tth, the threshold Gth, the threshold Lth, and the threshold Ith are used to determine occurrence of specific phenomena. Here, the threshold Tth, the threshold Gth, the threshold Lth, and the threshold Ith are described as actual values indicating the phenomena. Therefore, these may be different from set thresholds used when the CPU 401 determines the occurrence of specific phenomena. For example, in order to determine that the temperature T is the threshold Tth or less, whether the temperature T is a set threshold Tsth is determined.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-216890, filed Dec. 11, 2024, which is hereby incorporated by reference herein in its entirety.

What is claimed is:

1. An image forming apparatus comprising:
a photosensitive drum;
a transfer roller for transferring a developer on the photosensitive drum to a recording material;
a heating unit including an endless belt, and a heater that is provided on an inner surface side of the belt and heats the belt;
a pressure roller including a rubber layer that forms a fixing nip together with the heater via the belt;
a guiding member positioned between the transfer roller and the pressure roller in a conveyance direction in which the transfer roller conveys the recording material, the guiding member guiding a lower surface of the recording material so as to direct, toward the fixing nip, the recording material which has passed through a transfer nip, which is a nip between the photosensitive drum and the transfer roller;
a moving member that moves the guiding member to a first position or a second position positioned below the first position; and
a movement control unit that controls movement of the moving member,
wherein in a case where a temperature of the pressure roller is lower than a predetermined threshold, the movement control unit controls the moving member so that the guiding member is positioned at the second position, and
in a case where a temperature of the pressure roller is higher than the predetermined threshold, the movement control unit controls the moving member so that the guiding member is positioned at the first position.

2. The image forming apparatus according to claim 1, wherein in a case where a temperature of the pressure roller is lower than the predetermined threshold, the movement control unit controls the moving member so as to move the guiding member to the second position while the recording material is guided by the guiding member present at the first position.

3. The image forming apparatus according to claim 1, wherein in a case where a temperature of the pressure roller is lower than the predetermined threshold, the movement control unit controls the moving member so that the guiding member is positioned at the second position, and then the movement control unit controls the moving member so that the guiding member moves from the second position to the first position.

4. An image forming apparatus comprising:
a photosensitive drum;
a transfer roller for transferring a developer on the photosensitive drum to a recording material;
a heating unit including an endless belt, and a heater that is provided on an inner surface side of the belt and heats the belt;
a pressure roller including a rubber layer that forms a fixing nip together with the heater via the belt;
a guiding member positioned between the transfer roller and the pressure roller in a conveyance direction in which the transfer roller conveys the recording material, the guiding member guiding a lower surface of the recording material so as to direct, toward the fixing nip, the recording material which has passed through a transfer nip, which is a nip between the photosensitive drum and the transfer roller;
a moving member that moves the guiding member to a first position or a second position positioned below the first position;
a movement control unit that controls movement of the moving member; and
a basis weight detection unit that detects a basis weight of the recording material conveyed toward the heating unit,
wherein in a case where a basis weight of the recording material detected by the basis weight detection unit exceeds a threshold, the movement control unit controls the moving member so that the guiding member is positioned at the first position, and
in a case where a basis weight of the recording material detected by the basis weight detection unit does not exceed the threshold, the movement control unit controls the moving member so that the guiding member is positioned at the second position.

5. The image forming apparatus according to claim 4, wherein in a case where a basis weight of the recording material detected by the basis weight detection unit does not exceed the threshold, the movement control unit controls the moving member so as to move the guiding member to the second position while the recording material is guided by the guiding member present at the first position.

6. The image forming apparatus according to claim 4, wherein in a case where a basis weight of the recording material detected by the basis weight detection unit does not exceed the threshold, the movement control unit controls the moving member so that the guiding member is positioned at the second position, and then the movement control unit controls the moving member so that the guiding member moves from the second position to the first position.

7. An image forming apparatus comprising:
a photosensitive drum;
a transfer roller for transferring a developer on the photosensitive drum to a recording material;
a heating unit including an endless belt, and a heater that is provided on an inner surface side of the belt and heats the belt;
a pressure roller including a rubber layer that forms a fixing nip together with the heater via the belt;
a guiding member positioned between the transfer roller and the pressure roller in a conveyance direction in which the transfer roller conveys the recording material, the guiding member guiding a lower surface of the recording material so as to direct, toward the fixing nip, the recording material which has passed through a transfer nip, which is a nip between the photosensitive drum and the transfer roller;
a moving member that moves the guiding member to a first position or a second position positioned below the first position;
a movement control unit that controls movement of the moving member; and
a setting unit that sets a length of the recording material in the conveyance direction,
wherein a conveyance speed of the recording material of the transfer roller is higher than a conveyance speed of the recording material of the pressure roller,
in a case where the length set by the setting unit is larger than a predetermined threshold, the movement control unit controls the moving member so that the guiding member is positioned at the second position, and
in a case where the length set by the setting unit is smaller than the predetermined threshold, the movement control unit controls the moving member so that the guiding member is positioned at the first position.

8. The image forming apparatus according to claim 7, wherein in a case where the length set by the setting unit is larger than the predetermined threshold, the movement control unit controls the moving member so as to move the guiding member to the second position while the recording material is guided by the guiding member present at the first position.

9. The image forming apparatus according to claim 7, wherein in a case where the length set by the setting unit is larger than the predetermined threshold, the movement control unit controls the moving member so that the guiding member is positioned at the second position, and then the movement control unit controls the moving member so that the guiding member moves from the second position to the first position.

10. An image forming apparatus comprising:
a photosensitive drum;
a transfer roller for transferring a developer on the photosensitive drum to a recording material;
a heating unit including an endless belt, and a heater that is provided on an inner surface side of the belt and heats the belt;
a pressure roller including a rubber layer that forms a fixing nip together with the heater via the belt;
a guiding member positioned between the transfer roller and the pressure roller in a conveyance direction in which the transfer roller conveys the recording material, the guiding member guiding a lower surface of the recording material so as to direct, toward the fixing nip, the recording material which has passed through a transfer nip, which is a nip between the photosensitive drum and the transfer roller;
a moving member that moves the guiding member to a first position or a second position positioned below the first position; and
a movement control unit that controls movement of the moving member,
wherein a portion of the recording material included from a center to one end of the recording material in an axial direction of the photosensitive drum is defined as a first portion,
a portion of the recording material included from a center to an other end of the recording material in the axial direction is defined as a second portion,
in a case where an absolute value of a difference between a printing ratio of the first portion and a printing ratio of the second portion exceeds a predetermined threshold in printing information of the recording material, the movement control unit controls the moving member so that the guiding member is positioned at the second position, and
in a case where an absolute value of a difference between a printing ratio of the first portion and a printing ratio of the second portion does not exceed the predetermined threshold, the movement control unit controls the moving member so that the guiding member is positioned at the first position.

11. The image forming apparatus according to claim 10, wherein in a case where an absolute value of a difference between a printing ratio of the first portion and a printing ratio of the second portion exceeds the predetermined threshold, the movement control unit controls the moving member so as to move the guiding member to the second position while the recording material is guided by the guiding member present at the first position.

12. The image forming apparatus according to claim 10, wherein in a case where an absolute value of a difference between a printing ratio of the first portion and a printing ratio of the second portion exceeds the predetermined threshold, the movement control unit controls the moving member so that the guiding member is positioned at the second position, and then the movement control unit controls the moving member so that the guiding member moves from the second position to the first position.
